(19) United States
(12) Patent Application Publication
(10) Pub. No.: US 2015/0188437 A1
(43) Pub. Date: Jul. 2, 2015

(54) POWER SUPPLY APPARATUS, POWER SUPPLY SYSTEM WITH THE POWER SUPPLY APPARATUS, AND METHOD OF CONTROLLING THE SAME

(71) Applicant: DELTA ELECTRONICS, INC., Taoyuan County (TW)

(72) Inventor: Kai-Chuan CHAN, Taoyuan County (TW)

(21) Appl. No.: 14/314,359

(22) Filed: Jun. 25, 2014

(30) Foreign Application Priority Data
Dec. 31, 2013 (TW) 102149218

(51) Int. Cl. H02M 3/158; H02M 1/15; H02M 7/06

(52) U.S. Cl. CPC H02M 3/1584; H02M 7/06; H02M 1/15; H02M 2003/1586

(57) ABSTRACT

A power supply apparatus includes at least two power conversion circuits and a control circuit. The power conversion circuits are connected in parallel to each other and each power conversion circuit has a power switch and an inductive component. The inductive component is connected to the power switch to form one phase of the power conversion circuit and generate a phase output current. The control circuit generates a plurality of control signals, and the number of the control signals is identical to that of the power conversion circuits. The control circuit controls the power switches so that the phase output currents are superposed to generate an output current with low ripple components.

### BACKGROUND

1. Technical Field

The present disclosure relates generally to a power supply apparatus, a power system with the power supply apparatus, and a method of controlling the same, and more particularly to a power supply apparatus with low output current ripple components, a power system with the power supply apparatus, and the method of controlling the same.

2. Description of Related Art

In response to increasingly sophisticated semiconductor manufacturing technology, the requirements of power stability and accuracy are more stringent. For the conventional power supply, the linear regulation structure is adopted to achieve the power supply with a low ripple output. However, the linear regulation structure exists in issues of poor conversion efficiency.

The linear regulation structure mainly uses MOSFETs as switch elements and the MOSFETs are operated in the saturation region, thus effectively reducing ripple components. Because the switch elements of the conventional buck converter are floating connected on the main output path, a differential operation amplifier is used to produce switch drive signals for driving high side switches and provide voltage regulation by dividing the output voltage.

In addition, the linear regulation structure further exists in issues of poor circuit protection functions, such as over current protection (OCP), under voltage lockout (UVLO), inrush current protection (ICP), light load energy saving mechanism, and so on. In addition, the losses generated from the switch elements are gradually accumulated once the MOSFETs are operated in the saturation region for a long time.

For high precision equipment, semiconductor manufacturing equipment, or extra-high voltage (EHV) equipment, the requirements of low ripple components to the power supply apparatuses are stringent to increase conversion efficiency and reduce probability of malfunction of the power supply apparatus.

Accordingly, it is desirable to provide a power supply apparatus, a power supply system with the power supply apparatus, and a method of controlling the same to realize both reduction of ripple components and voltage regulation of the output voltage by a multi-phase interleaving manner and a resistor network division circuit.

### SUMMARY

An object of the present disclosure is to provide a power supply apparatus to solve the above-mentioned problems. Accordingly, the A power supply apparatus includes at least two power conversion circuits and a control circuit. The at least two power conversion circuits are connected in parallel to each other, and each power conversion circuit has a power switch and an inductive. The inductive component is connected to the power switch to form one phase of the power conversion circuits and generate a phase output current. The control circuit generates a plurality of control signals, and the number of the control signals is identical to the number of the power conversion circuits. The control circuit controls the power switches by a phase interleaving manner to generate an output current with low ripple components superposed by the phase output currents.

Wherein, the control signals outputted from the control circuit are shifted by an angle to each other for correspondingly controlling the power switches.

Wherein, the power supply apparatus further includes a voltage regulation circuit. The voltage regulation circuit is electrically connected to an output terminal where the output current flows in, and has a first feedback resistor and a second feedback resistor; the first feedback resistor and the second feedback resistor are configured to divide an output voltage with low ripple components at the output terminal.

Wherein, the angle is equal to a ratio between an electrical angle in each cycle and the number of the power conversion circuits.

Wherein, the number of the power conversion circuits is three when the power supply apparatus is a three-phase power supply apparatus, and the angle is equal to 120 degrees or 2π/3 radians.

Wherein, the power supply apparatus is a buck converter structure, a boost converter structure, a Cuk converter structure, or a Zeta converter structure.

Another object of the present disclosure is to provide a power system to solve the above-mentioned problems. Accordingly, the power system includes an AC power source, a rectifying circuit, and a power supply apparatus. The rectifying circuit receives the AC power source and rectifies the AC power source to generate an input DC voltage. The power supply apparatus includes at least two power conversion circuits and a control circuit. The power conversion circuits are connected in parallel to each other, and each power conversion circuit receives the input DC voltage and has a power switch and an inductive. The inductive component is connected to the power switch to form one phase of the power conversion circuits and generates a phase output current. The control circuit generates a plurality of control signals, and the number of the control signals is identical to the number of the power conversion circuits; the control circuit controls the power switches by a phase interleaving manner to generate an output current with low ripple components superposed by the phase output currents to supply a load.

Wherein, the control signals outputted from the control circuit are shifted by an angle to each other for correspondingly controlling the power switches.

Wherein, the power supply apparatus further includes a voltage regulation circuit. The voltage regulation circuit is electrically connected to an output terminal where the output current flows in, and has a first feedback resistor and a second feedback resistor; the first feedback resistor and the second feedback resistor are configured to divide an output voltage with low ripple components at the output terminal.

Wherein, the angle is equal to a ratio between an electrical angle in each cycle and the number of the power conversion circuits.

Wherein, the number of the power conversion circuits is three when the power supply apparatus is a three-phase power supply apparatus, and the angle is equal to 120 degrees or 2π/3 radians.

Wherein, the power supply apparatus is a buck converter structure, a boost converter structure, a Cuk converter structure, or a Zeta converter structure.

Further another object of the present disclosure is to provide a method of controlling a power supply apparatus and a power supply system with the power supply apparatus, the method includes following steps: (a) at least two power conversion circuits are provided, each power conversion circuit has a power switch and an inductive component connected to the power switch to form one phase of the power conversion circuits and generate a phase output current; (b) a control circuit is provided, the control circuit generates a plurality of control signals, and the number of the control signals is identical to the number of the power conversion circuits; and (c) the power switches are correspondingly controlled by the control signals by a phase interleaving manner to generate an output current with low ripple components superposed by the phase output currents.

Wherein, the control signals outputted from the control circuit are shifted by an angle to each other for correspondingly controlling the power switches.

Wherein, the method further includes: (d) a voltage regulation circuit is provided, the voltage regulation circuit is electrically connected to an output terminal where the output current flows in, and has a first feedback resistor and a second feedback resistor; the first feedback resistor and the second feedback resistor are provided to divide an output voltage with low ripple components at the output terminal.

Wherein, the angle is equal to a ratio between an electrical angle in each cycle and the number of the power conversion circuits.

Wherein, the number of the power conversion circuits is three when the power supply apparatus is a three-phase power supply apparatus, and the angle is equal to 120 degrees or 2π/3 radians.

Wherein, the power supply apparatus is a buck converter structure, a boost converter structure, a Cuk converter structure, or a Zeta converter structure.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a circuit diagram of a power supply apparatus with low output current ripple according to a first embodiment of the present disclosure;

FIG. 2 is a circuit diagram of the power supply apparatus with low output current ripple according to a second embodiment of the present disclosure;

FIG. 3 is a circuit diagram of the power supply apparatus with low output current ripple according to a third embodiment of the present disclosure;

FIG. 4 is a circuit diagram of the power supply apparatus with low output current ripple according to a fourth embodiment of the present disclosure;

FIG. 5 is a schematic waveform of controlling the power supply apparatus in a multi-phase interleaving manner according to the present disclosure;

FIG. 6 is a schematic view of ripple components comparison of the power supply apparatus in the multi-phase interleaving manner according to the present disclosure;

FIG. 7 is a schematic circuit block diagram of a power system having the power supply apparatus according to a first embodiment of the present disclosure;

FIG. 8 is a schematic circuit block diagram of the power system having the power supply apparatus according to a second embodiment of the present disclosure;

FIG. 9 is a schematic circuit block diagram of the power system having the power supply apparatus according to a third embodiment of the present disclosure;

FIG. 10 is a schematic circuit block diagram of the power system having the power supply apparatus according to a fourth embodiment of the present disclosure; and

FIG. 11 is a flowchart of a method of controlling the power supply apparatus with low output current ripple according to the present disclosure.

### DETAILED DESCRIPTION

Reference will now be made to the drawing figures to describe the present invention in detail.

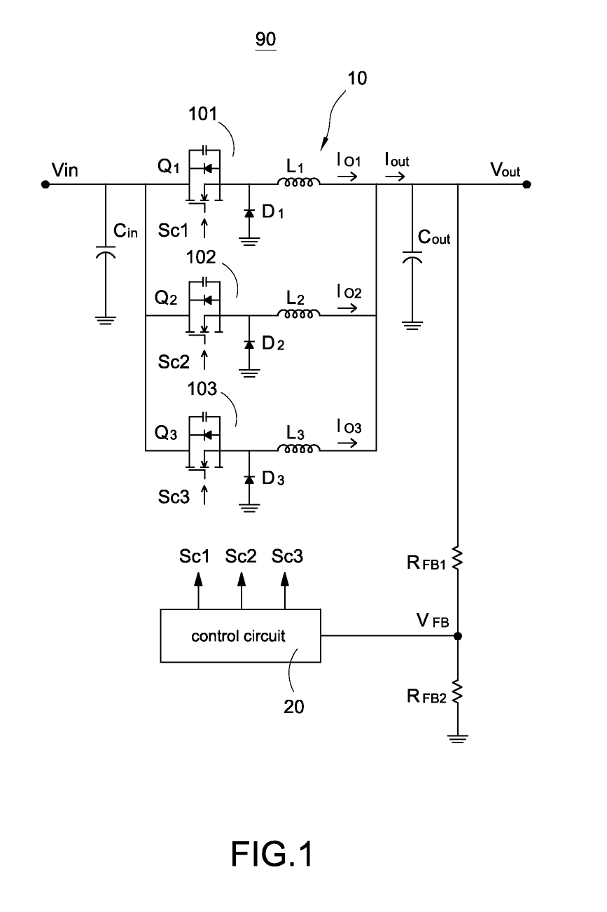

Reference is made to FIG. 1 which is a circuit diagram of a power supply apparatus with low output current ripple according to a first embodiment of the present disclosure. The power supply apparatus is substantially a buck converter structure. The power supply apparatus includes at least two power conversion circuits 10 and a control circuit 20. The power conversion circuits 10 are connected in parallel to each other, and each power conversion circuit 10 has a power switch Q and an inductor L. The inductor L is connected in series to the power switch Q to form one phase of the power conversion circuits 10 and generate a phase output current Io. The control circuit 20 generates a plurality of control signals, and the number of the control signals is identical to that of the power conversion circuits 10. Also, the control signals are provided to correspondingly control the power switches Q by the phase interleaving manner to generate an output current Iout with low ripple components superposed by the phase output currents Io. The detailed operation of the power supply apparatus with low output current ripple components will be described hereinafter as follows.

For convenience, the three-phase power supply apparatus is exemplified to further demonstrate the present invention. That is, the power conversion circuit 10 includes a first power conversion circuit 101, a second power conversion circuit 102, and a third power conversion circuit 103. The power conversion circuits 101, 102, 103 are electrically connected to an input voltage Vin which is provided by rectifying an external AC voltage. The first power conversion circuit 101 has a first power switch Q1, a first inductor L1, and a first diode D1. The first inductor L1 is connected in series to the first power switch Q1 and then connected to the first diode D1 to form a first phase of the power conversion circuits 10 and generate a first phase output current Io₁. The second power conversion circuit 102 has a second power switch Q2, a second inductor L2, and a second diode D2. The second inductor L2 is connected in series to the second power switch Q2 and then connected to the second diode D2 to form a second phase of the power conversion circuits 10 and generate a second phase output current Io₂. The third power conversion circuit 103 has a third power switch Q3, a third inductor L3, and a third diode D3. The third inductor L3 is connected in series to the third power switch Q3 and then connected to the third diode D3 to form a third phase of the power conversion circuits 10 and generate a third phase output current Io₃. The control circuit 20 generates three control signals, namely a first control signal Sc1, a second control signal Sc2, and a third control signal Sc3, to correspondingly control the first power switch Q1, the second power switch Q2, and the third power switch Q3. Especially, the control circuit 20 outputs the first control signal Sc1, the second control signal Sc2, and the third control signal Sc3 by the phase interleaving manner to correspondingly control the first power switch Q1, the second power switch Q2, and the third power switch Q3.

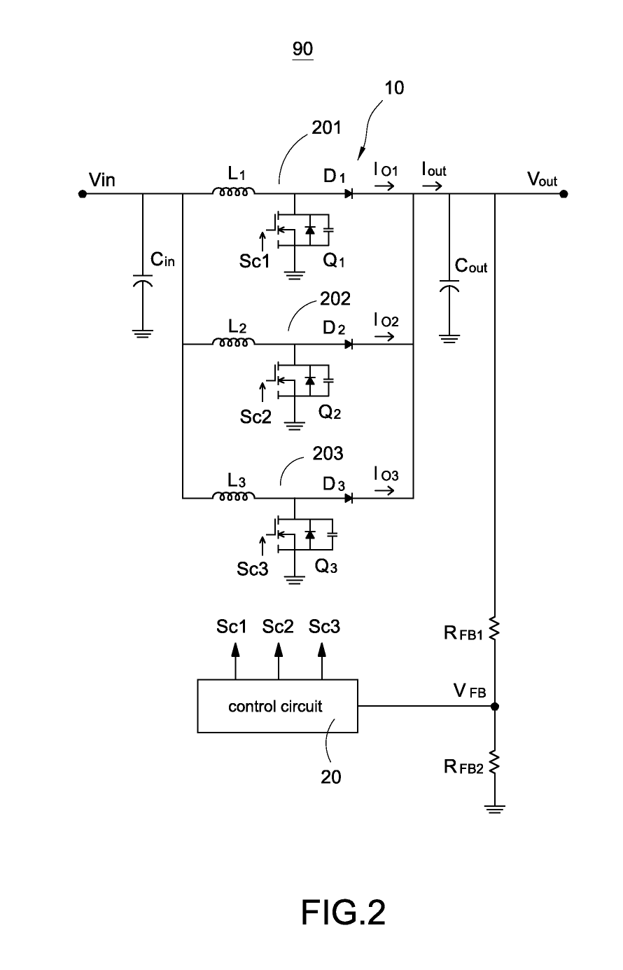

Reference is made to FIG. 2 which is a circuit diagram of the power supply apparatus with low output current ripple according to a second embodiment of the present disclosure. The power supply apparatus is substantially a boost converter structure. The power supply apparatus includes at least two power conversion circuits 10 and a control circuit 20. The power conversion circuit 10 includes a first power conversion circuit 201, a second power conversion circuit 202, and a third power conversion circuit 203.

The power conversion circuits 201, 202, 203 are electrically connected to an input voltage Vin which is provided by rectifying an external AC voltage. The first power conversion circuit 201 has a first power switch Q1, a first inductor L1, and a first diode D1. The first inductor L1 is connected in series to the first diode D1 and then connected to the first power switch Q1 to form a first phase of the power conversion circuits 10 and generate a first phase output current Io₁. The second power conversion circuit 202 has a second power switch Q2, a second inductor L2, and a second diode D2. The second inductor L2 is connected in series to the second diode D2 and then connected to the second power switch Q2 to form a second phase of the power conversion circuits 10 and generate a second phase output current Io₂. The third power conversion circuit 203 has a third power switch Q3, a third inductor L3, and a third diode D3. The third inductor L3 is connected in series to the third diode D3 and then connected to the third power switch Q3 to form a third phase of the power conversion circuits 10 and generate a third phase output current Io₃. The control circuit 20 generates three control signals, namely a first control signal Sc1, a second control signal Sc2, and a third control signal Sc3, to correspondingly control the first power switch Q1, the second power switch Q2, and the third power switch Q3. Especially, the control circuit 20 outputs the first control signal Sc1, the second control signal Sc2, and the third control signal Sc3 by the phase interleaving manner to correspondingly control the first power switch Q1, the second power switch Q2, and the third power switch Q3.

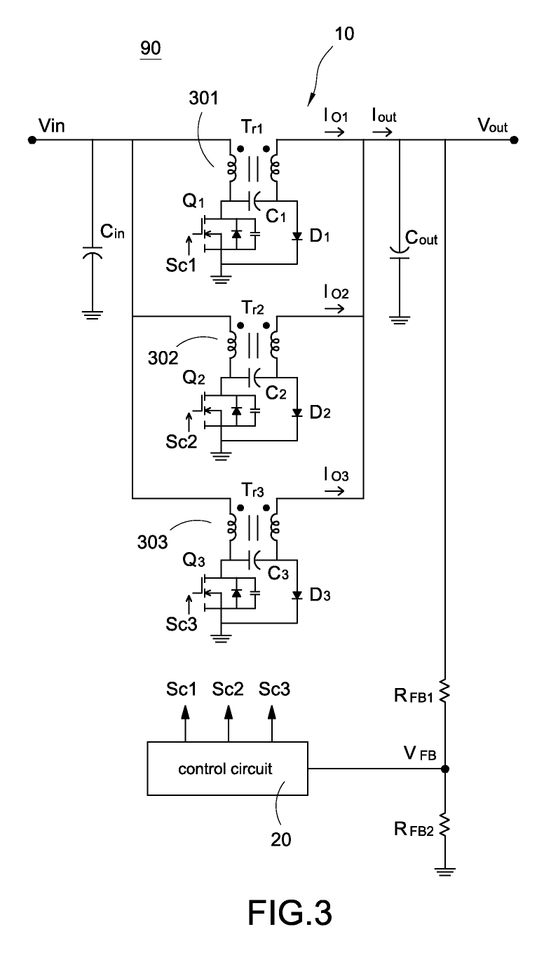

Reference is made to FIG. 3 which is a circuit diagram of the power supply apparatus with low output current ripple according to a third embodiment of the present disclosure. The power supply apparatus is substantially a Cuk converter structure. The power supply apparatus includes at least two power conversion circuits 10 and a control circuit 20. The power conversion circuit 10 includes a first power conversion circuit 301, a second power conversion circuit 302, and a third power conversion circuit 303.

The power conversion circuits 301, 302, 303 are electrically connected to an input voltage Vin which is provided by rectifying an external AC voltage. The first power conversion circuit 301 has a first transformer Tr1, a first capacitor C1, a first power switch Q1, and a first diode D1. The first power switch Q1, the first capacitor C1, and the first diode D1 are connected in series and then connected to the first transformer Tr1 to form a first phase of the power conversion circuits 10 and generate a first phase output current Io₁. The second power conversion circuit 302 has a second transformer Tr2, a second capacitor C2, a second power switch Q2, and a second diode D2. The second power switch Q2, the second capacitor C2, and the second diode D2 are connected in series and then connected to the second transformer Tr2 to form a second phase of the power conversion circuits 10 and generate a second phase output current Io₂. The third power conversion circuit 303 has a third transformer Tr3, a third capacitor C3, a third power switch Q3, and a third diode D3. The third power switch Q3, the third capacitor C3, and the third diode D3 are connected in series and then connected to the third transformer Tr3 to form a third phase of the power conversion circuits 10 and generate a third phase output current Io₃. The control circuit 20 generates three control signals, namely a first control signal Sc1, a second control signal Sc2, and a third control signal Sc3, to correspondingly control the first power switch Q1, the second power switch Q2, and the third power switch Q3. Especially, the control circuit 20 outputs the first control signal Sc1, the second control signal Sc2, and the third control signal Sc3 by the phase interleaving manner to correspondingly control the first power switch Q1, the second power switch Q2, and the third power switch Q3.

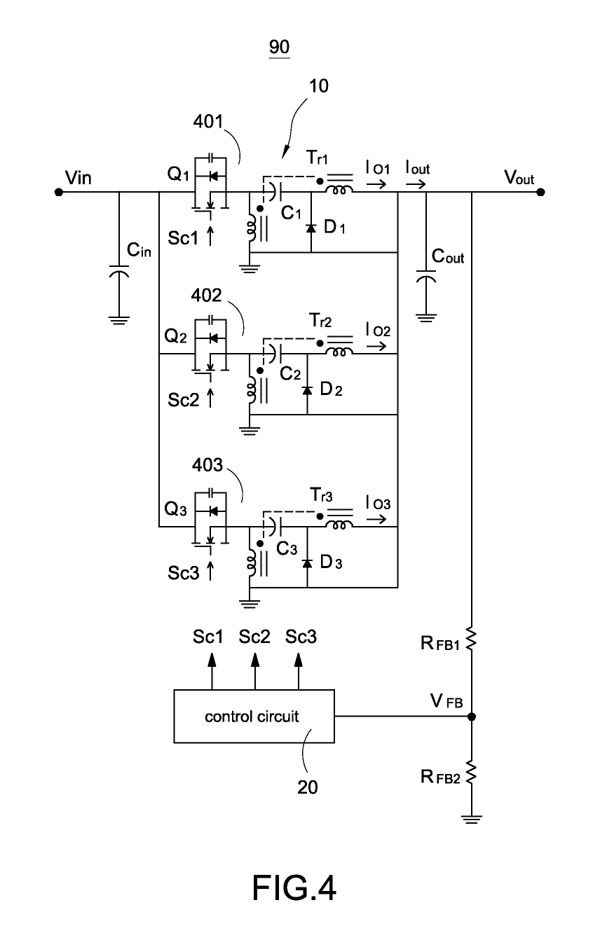

Reference is made to FIG. 4 which is a circuit diagram of the power supply apparatus with low output current ripple according to a fourth embodiment of the present disclosure. The power supply apparatus is substantially a Zeta converter structure. The power supply apparatus includes at least two power conversion circuits 10 and a control circuit 20. The power conversion circuit 10 includes a first power conversion circuit 401, a second power conversion circuit 402, and a third power conversion circuit 403.

The power conversion circuits 401, 402, 403 are electrically connected to an input voltage Vin which is provided by rectifying an external AC voltage. The first power conversion circuit 401 has a first power switch Q1, a first transformer Tr1, a first capacitor C1, and a first diode D1. The first transformer Tr1, the first capacitor C1, and the first diode D1 are connected in series and then connected to the first power switch Q1 to form a first phase of the power conversion circuits 10 and generate a first phase output current Io₁. The second power conversion circuit 402 has a second power switch Q2, a second transformer Tr2, a second capacitor C2, and a second diode D2. The second transformer Tr2, the second capacitor C2, and the second diode D2 are connected in series and then connected to the second power switch Q2 to form a second phase of the power conversion circuits 10 and generate a second phase output current Io₂. The third power conversion circuit 403 has a third power switch Q3, a third transformer Tr3, a third capacitor C3, and a third diode D3. The third transformer Tr3, the third capacitor C3, and the third diode D3 are connected in series and then connected to the third power switch Q3 to form a third phase of the power conversion circuits 10 and generate a third phase output current Io₃. The control circuit 20 generates three control signals, namely a first control signal Sc1, a second control signal Sc2, and a third control signal Sc3, to correspondingly control the first power switch Q1, the second power switch Q2, and the third power switch Q3. Especially, the control circuit 20 outputs the first control signal Sc1, the second control signal Sc2, and the third control signal Sc3 by the phase interleaving manner to correspondingly control the first power switch Q1, the second power switch Q2, and the third power switch Q3.

More specifically, the phase interleaving manner means that a fixed angle Θ is interleaved or shifted between the control signals. In particular, the fixed angle Θ is equal to a ratio between an electrical angle in each cycle, namely 360 degrees or 2π radians, and the number of the power conversion circuits 10. In this embodiment, the fixed angle Θ=120 degrees, namely, Θ=360/3=120 degrees. In other words, when the first control signal Sc1 is outputted by the control circuit 20 at ωt radians, the second control signal Sc2 is outputted at ωt+120 radians and the third control signal Sc3 is outputted at ωt+240 radians. Especially, if the power conversion circuit 10 is a four-phase structure, the fixed angle Θ is equal to 90 degrees, namely, Θ=360/4=90. In other words, when the first control signal Sc1 is outputted at ωt radians, the consecutive control signals are outputted at ωt+90, ωt+180, and ωt+270, respectively.

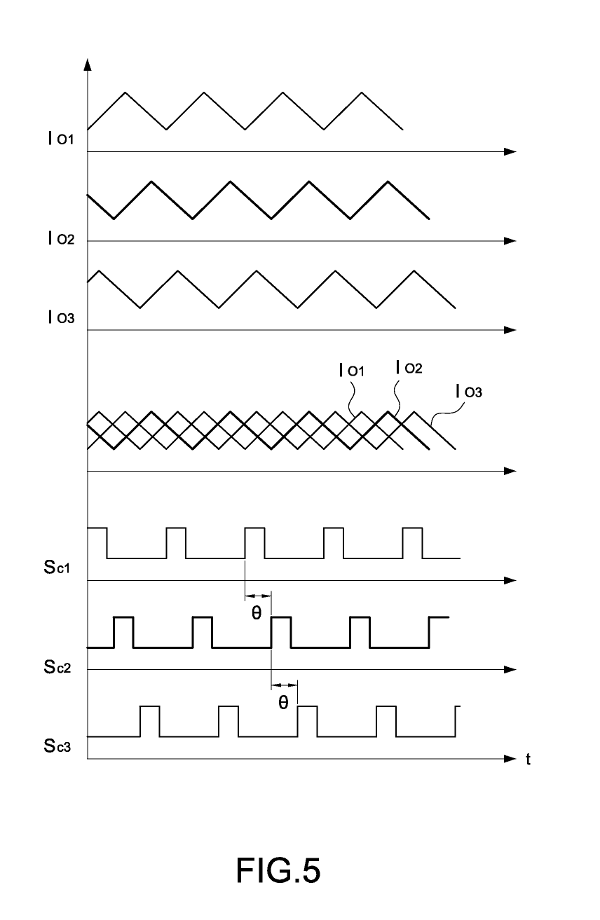

Reference is made to FIG. 5 which is a schematic waveform of controlling the power supply apparatus in a multi-phase interleaving manner according to the present disclosure. From top to down, FIG. 5 illustrates the waveform of the first phase output current Io₁, the second phase output current Io₂, the third phase output current Io₃, the first control signal Sc1, the second control signal Sc2, and the third control signal Sc3, respectively. Because the first power switch Q1, the second power switch Q2, and the third power switch Q3 are controlled by the first control signal Sc1, the second control signal Sc2, and the third control signal Sc3, the phase of the second phase output current Io₂ is shifted the fixed angle Θ to the phase of the first phase output current Io₁. Similarly, the phase of the third phase output current Io₃ is shifted the fixed angle Θ to the phase of the second phase output current Io₂. Especially, an output current Iout is equal to the sum of the first phase output current Io₁, the second phase output current Io₂, and the third phase output current Io₂, namely Iout=Io₁+Io₂+Io₃ because the power conversion circuits 10 are connected in parallel to each other.

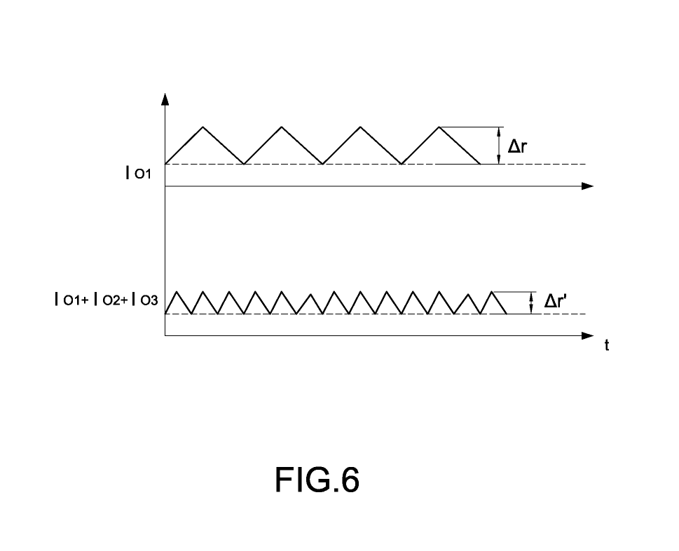

Reference is made to FIG. 6 which is a schematic view of ripple components comparison of the power supply apparatus in a multi-phase interleaving manner according to the present disclosure. The waveforms of the first phase output current Io₁ and the output current Iout are shown at the upper part and the low part of the FIG. 6, respectively. The first phase output current Io₁ (the single phase output current) has ripple components Δr and the output current Iout superposed by the phase output currents has ripple components Δr′. Obviously, the ripple components Δr′ of the output current Iout are much less than the ripple components Δr of the single phase output current. Hence, the multi-phase interleaving control can significantly reduce the ripple components of the output current. In addition, the output voltage Vout generated at an output terminal where the output current Iout flows in and connected to a rear-end load Ro also has the feature of low ripple components. Accordingly, the multi-phase interleaving control can be applied to the power supply apparatuses with low output current ripple components for application fields of high precision equipment, semiconductor manufacturing equipment, or extra-high voltage (EHV) equipment.

In addition, the power supply apparatus further has a voltage regulation circuit for the output voltage Vout shown in FIG. 1 to FIG. 4. In this embodiment, a resistor network composed of a first feedback resistor R_{FB1} and a second feedback resistor R_{FB2} is provided to divide the output voltage Vout into a feedback voltage V_{FB}. In particular, the feedback voltage V_{FB} is compared to a reference voltage (not shown) so that the control circuit 20 outputs the first control signal Sc1, the second control signal Sc2, and the third control signal Sc3. Accordingly, both the low ripple components and the voltage regulation of the output voltage Vout can be implemented.

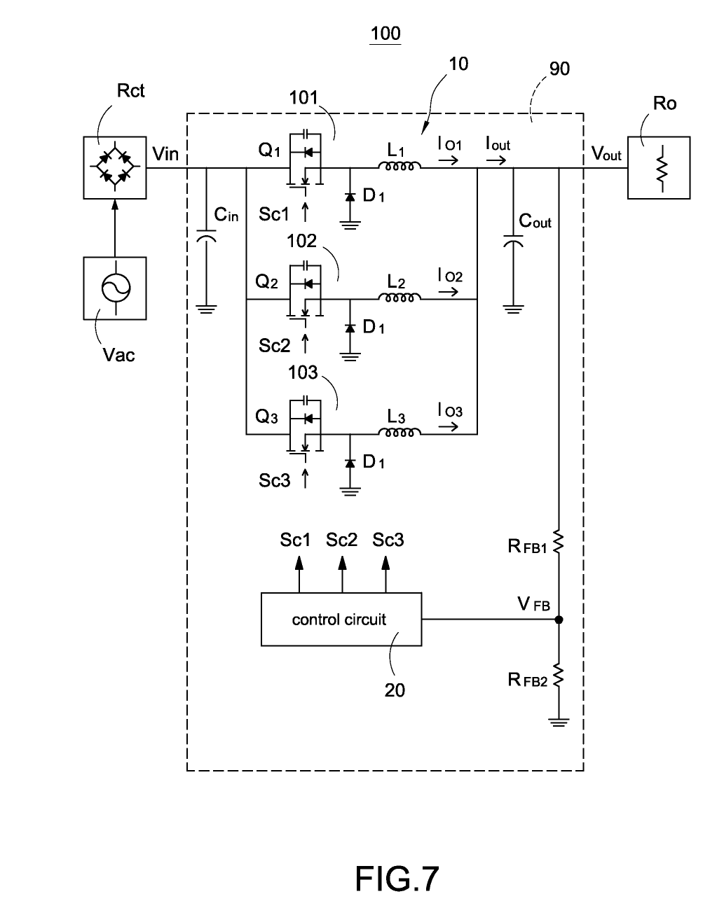

Reference is made to FIG. 7 which is a schematic circuit block diagram of a power system having the power supply apparatus according to a first embodiment of the present disclosure. The power system 100 includes an AC power source Vac, a rectifying circuit Rct, and a power supply apparatus 90. The rectifying circuit Rct receives the AC power source Vac and rectifies the AC power source Vac to generate an input DC voltage Vin. The power supply apparatus 90 includes at least two power conversion circuits 10 and a control circuit 20. The power conversion circuits 10 are connected in parallel to each other, and each power conversion circuit 10 receives the input DC voltage Vin and has a power switch Q and an inductor L. The inductor L is connected in series to the power switch Q to form one phase of the power conversion circuits 10 and generate a phase output current Io. The control circuit 20 generates a plurality of control signals, and the number of the control signals is identical to that of the power conversion circuits. Also, the control signals are provided to correspondingly control the power switches Q by the phase interleaving manner to generate an output current Iout with low ripple components superposed by the phase output currents Io to supply a load Ro.

For convenience, the three-phase power supply apparatus is exemplified to further demonstrate the present invention. That is, the power conversion circuit 10 includes a first power conversion circuit 101, a second power conversion circuit 102, and a third power conversion circuit 103. The control circuit 20 generates three control signals, namely a first control signal Sc1, a second control signal Sc2, and a third control signal Sc3, to correspondingly control the first power switch Q1, the second power switch Q2, and the third power switch Q3. Especially, the control circuit 20 outputs the first control signal Sc1, the second control signal Sc2, and the third control signal Sc3 by the phase interleaving manner to correspondingly control the first power switch Q1, the second power switch Q2, and the third power switch Q3. When the first control signal Sc1 is outputted by the control circuit 20 at ωt radians, the second control signal Sc2 is outputted at ωt+120 radians and the third control signal Sc3 is outputted at ωt+240 radians. Accordingly, the multi-phase interleaving control can be applied to the power supply apparatuses with low output current ripple components for application fields of high precision equipment, semiconductor manufacturing equipment, or extra-high voltage (EHV) equipment.

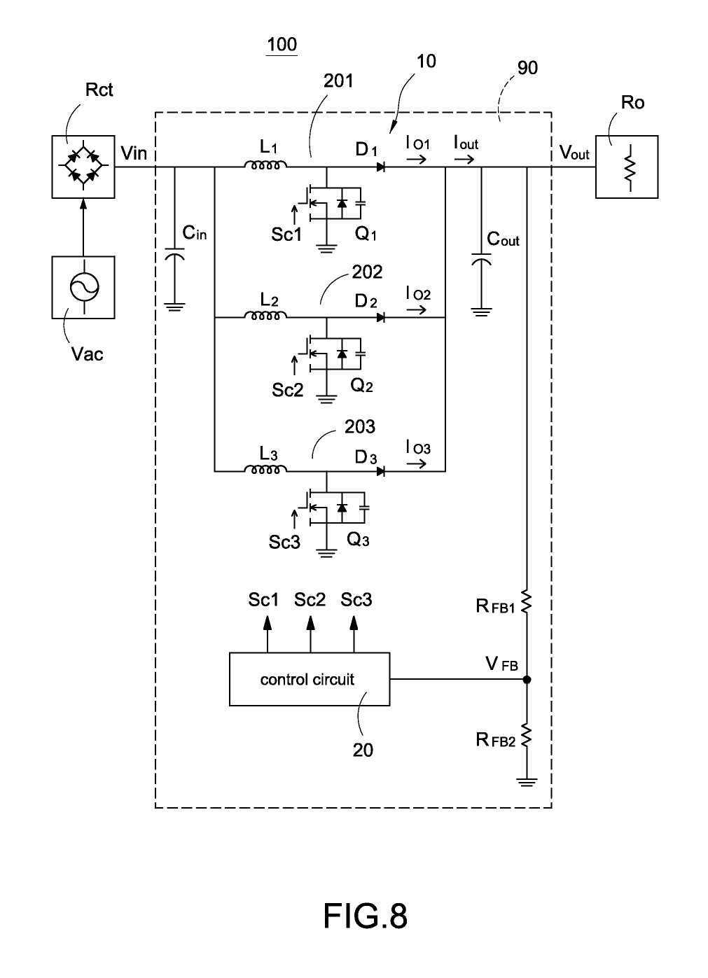

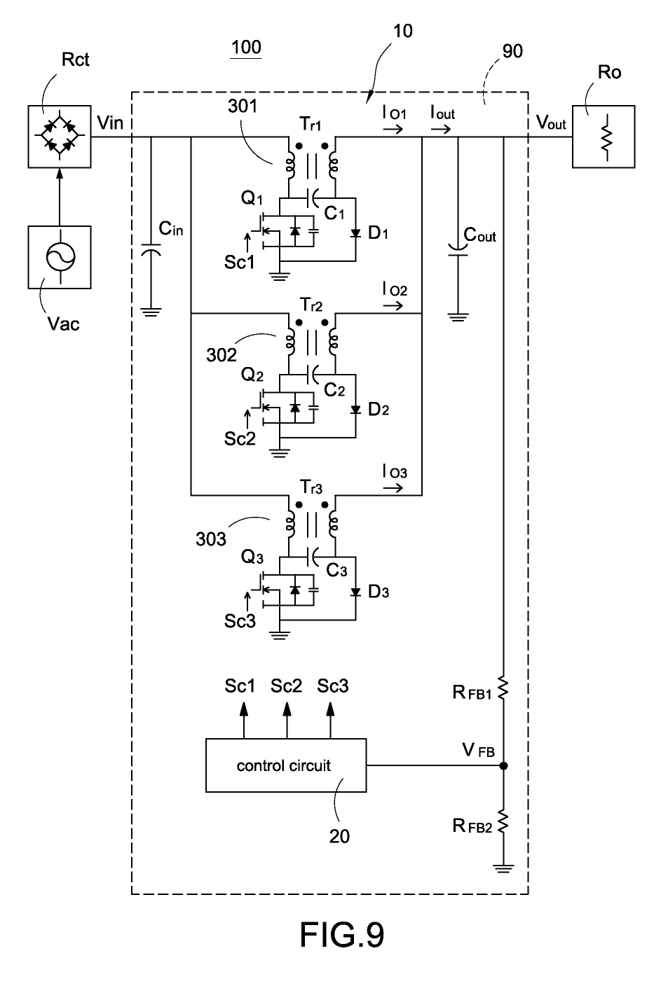

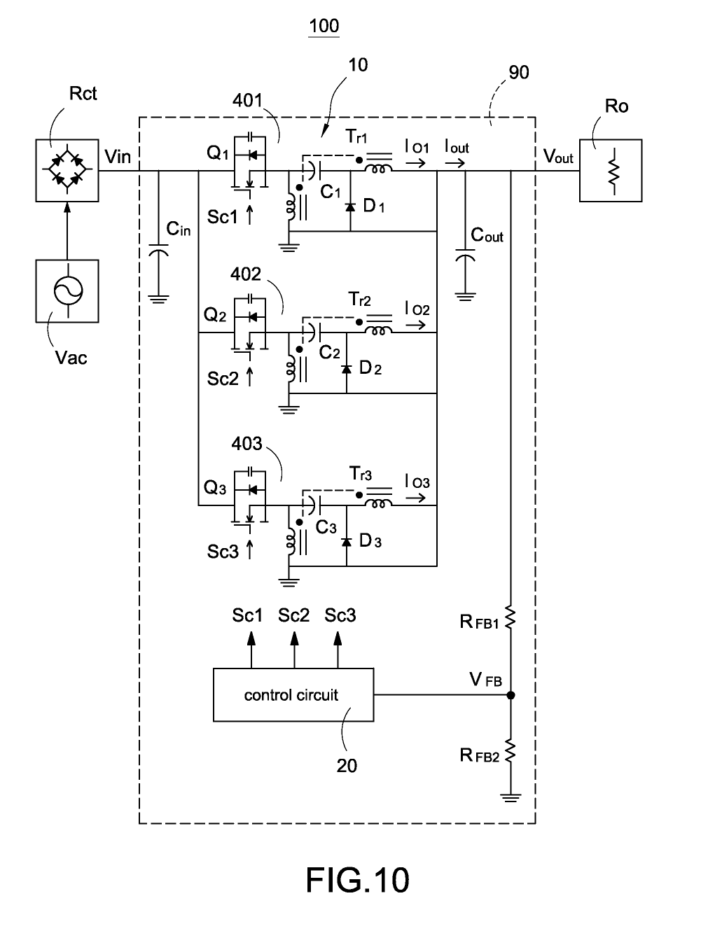

In addition, reference is made to FIG. 8, FIG. 9, and FIG. 10 which are a schematic circuit block diagram of the power system having the power supply apparatus according to a second embodiment, a third embodiment, and a fourth embodiment of the present disclosure, respectively. In other words, FIG. 8 illustrates the system applied to the boost converter structure in FIG. 2. FIG. 9 illustrates the system applied to the Cuk converter structure in FIG. 3. FIG. 10 illustrates the system applied to the Zeta converter structure in FIG. 4. Accordingly, the system operations in FIG. 8, FIG. 9, and FIG. 10 can refer to the system operation in FIG. 7.

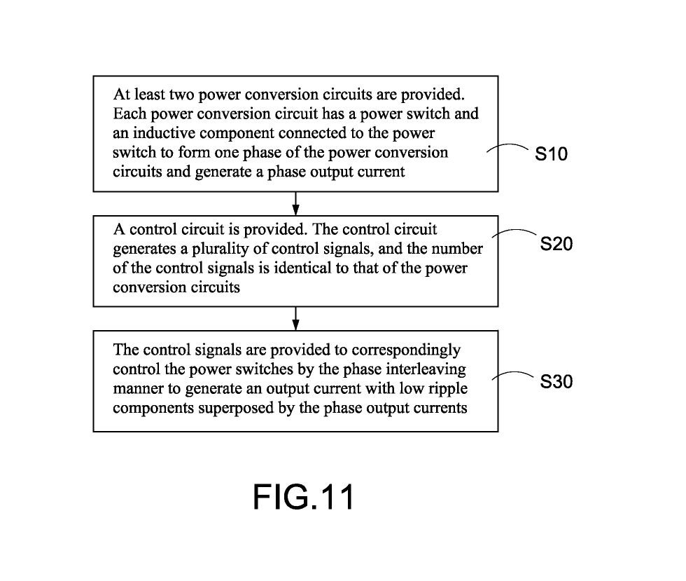

Reference is made to FIG. 11 which is a flowchart of a method of controlling the power supply apparatus with low output current ripple according to the present disclosure. The control method includes following steps: First, at least two power conversion circuits are provided (S10). Each power conversion circuit has a power switch and an inductive component connected to the power switch to form one phase of the power conversion circuits and generate a phase output current. The three-phase power supply apparatus is exemplified to further demonstrate the present invention. The power conversion circuit 10 includes a first power conversion circuit, a second power conversion circuit, and a third power conversion circuit. The power conversion circuits are electrically connected to an input voltage which is provided by rectifying an external AC voltage. The first power conversion circuit has a first power switch, a first inductor, and a first diode. The first inductor is connected in series to the first power switch and then connected to the first diode to form a first phase of the power conversion circuits and generate a first phase output current. The second power conversion circuit has a second power switch, a second inductor, and a second diode. The second inductor is connected in series to the second power switch and then connected to the second diode to form a second phase of the power conversion circuits and generate a second phase output current. The third power conversion circuit has a third power switch, a third inductor, and a third diode. The third inductor is connected in series to the third power switch and then connected to the third diode to form a third phase of the power conversion circuits and generate a third phase output current.

Afterward, a control circuit is provided (S20). The control circuit is configured to generate a plurality of control signals, and the number of the control signals is identical to that of the power conversion circuits. The three-phase power supply apparatus is exemplified to further demonstrate the present invention. The control circuit generates three control signals, namely a first control signal, a second control signal, and a third control signal to correspondingly control the first power switch, the second power switch, and the third power switch. Especially, the control circuit outputs the first control signal, the second control signal, and the third control signal by the phase interleaving manner to correspondingly control the first power switch, the second power switch, and the third power switch.

Finally, the control signals are provided to correspondingly control the power switches by the phase interleaving manner to generate an output current with low ripple components superposed by the phase output currents (S30). More specifically, the phase interleaving manner means that a fixed angle Θ is interleaved or shifted between the control signals. In particular, the fixed angle Θ is equal to a ratio between an electrical angle in each cycle, namely 360 degrees or 2π radians, and the number of the power conversion circuits. In this embodiment, the fixed angle Θ=120 degrees, namely, Θ=360/3=120 degrees. In other words, when the first control signal is outputted by the control circuit at ωt radians, the second control signal is outputted at ωt+120 radians and the third control signal is outputted at ωt+240 radians.

Because the first power switch, the second power switch, and the third power switch are controlled by the first control signal, the second control signal, and the third control signal, the phase of the second phase output current is shifted the fixed angle to the phase of the first phase output current. Similarly, the phase of the third phase output current is shifted the fixed angle Θ to the phase of the second phase output current. Accordingly, the multi-phase interleaving control can be applied to the power supply apparatuses with low output current ripple components for application fields of high precision equipment, semiconductor manufacturing equipment, or extra-high voltage (EHV) equipment.

In conclusion, the present disclosure has following advantages:

1. The control signals outputted from the control circuit 20 are interleaved or shifted to each other by a fixed angle Θ to implement the multi-phase interleaving control; and the multi-phase interleaving control is applied to multiple-phase power conversion circuits to increase applicability of the power conversion structures;

2. The phase output currents are superposed to generate the output current to significantly reduce the ripple components of the output current. Relatively, the output voltage Vout has also the feature of low ripple components. Accordingly, the multi-phase interleaving control can be applied to the power supply apparatuses with low output current ripple components for application fields of high precision equipment, semiconductor manufacturing equipment, or extra-high voltage (EHV) equipment;

3. The power supply apparatus with low current ripple components can be suitable for different converter topologies, such as buck converters, boost converters, Cuk converters, or Zeta converters so that significantly increase breadth and depth of using the power supply apparatuses depending on the user's demands; and

4. The resistor network is used to divide the output voltage into a feedback voltage to provide the voltage regulation of the output voltage. Accordingly, both the low ripple components and the voltage regulation of the output voltage can be implemented.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power supply apparatus comprising:
at least two power conversion circuits connected in parallel to each other, and each power conversion circuit having:
a power switch; and
an inductive component connected to the power switch to form one phase of the power conversion circuits and generate a phase output current; and
a control circuit configured to generate a plurality of control signals, and the number of the control signals is identical to the number of the power conversion circuits; the control circuit configured to control the power switches by a phase interleaving manner to generate an output current with low ripple components superposed by the phase output currents.

2. The power supply apparatus in claim 1, wherein the control signals outputted from the control circuit are shifted by an angle to each other for correspondingly controlling the power switches.

3. The power supply apparatus in claim 1, further comprising:
a voltage regulation circuit electrically connected to an output terminal where the output current flows in, and having a first feedback resistor and a second feedback resistor; the first feedback resistor and the second feedback resistor are configured to divide an output voltage with low ripple components at the output terminal.

4. The power supply apparatus in claim 2, wherein the angle is equal to a ratio between an electrical angle in each cycle and the number of the power conversion circuits.

5. The power supply apparatus in claim 4, wherein the number of the power conversion circuits is three when the power supply apparatus is a three-phase power supply apparatus, and the angle is equal to 120 degrees or 2π/3 radians.

6. The power supply apparatus in claim 1, wherein the power supply apparatus is a buck converter structure, a boost converter structure, a Cuk converter structure, or a Zeta converter structure.

7. A power system comprising:
an AC power source;
a rectifying circuit configured to receive the AC power source and rectify the AC power source to generate an input DC voltage; and
a power supply apparatus, comprising:
at least two power conversion circuits connected in parallel to each other, and each power conversion circuit configured to receive the input DC voltage and having:
a power switch; and
an inductive component connected to the power switch to form one phase of the power conversion circuits and generate a phase output current; and
a control circuit configured to generate a plurality of control signals, and the number of the control signals is identical to the number of the power conversion circuits; the control circuit configured to control the power switches by a phase interleaving manner to generate an output current with low ripple components superposed by the phase output currents to supply a load.

8. The power system in claim 7, wherein the control signals outputted from the control circuit are shifted by an angle to each other for correspondingly controlling the power switches.

9. The power system in claim 7, wherein the power supply apparatus comprises:
a voltage regulation circuit electrically connected to an output terminal where the output current flows in, and having a first feedback resistor and a second feedback resistor; the first feedback resistor and the second feedback resistor are configured to divide an output voltage with low ripple components at the output terminal.

10. The power system in claim 8, wherein the angle is equal to a ratio between an electrical angle in each cycle and the number of the power conversion circuits.

11. The power system in claim 10, wherein the number of the power conversion circuits is three when the power supply apparatus is a three-phase power supply apparatus, and the angle is equal to 120 degrees or 2π/3 in radians.

12. The power system in claim 7, wherein the power supply apparatus is a buck converter structure, a boost converter structure, a Cuk converter structure, or a Zeta converter structure.

13. A method of controlling a power supply apparatus, comprising following steps:
(a) providing at least two power conversion circuits, each power conversion circuit having a power switch and an inductive component connected to the power switch to form one phase of the power conversion circuits and generate a phase output current;
(b) providing a control circuit, the control circuit configured to generate a plurality of control signals, and the number of the control signals is identical to the number of the power conversion circuits; and
(c) correspondingly controlling the power switches by the control signals by a phase interleaving manner to generate an output current with low ripple components superposed by the phase output currents.

14. The method of controlling the power supply apparatus in claim 13, wherein the control signals outputted from the control circuit are shifted by an angle to each other for correspondingly controlling the power switches.

15. The method of controlling the power supply apparatus in claim 13, further comprising:
(d) providing a voltage regulation circuit, the voltage regulation circuit electrically connected to an output terminal where the output current flows in, and having a first feedback resistor and a second feedback resistor; the first feedback resistor and the second feedback resistor are configured to divide an output voltage with low ripple components at the output terminal.

16. The method of controlling the power supply apparatus in claim 14, wherein the angle is equal to a ratio between an electrical angle in each cycle and the number of the power conversion circuits.

17. The method of controlling the power supply apparatus in claim 16, wherein the number of the power conversion circuits is three when the power supply apparatus is a three-phase power supply apparatus, and the angle is equal to 120 degrees or 2π/3 radians.

18. The method of controlling the power supply apparatus in claim 13, wherein the power supply apparatus is a buck converter structure, a boost converter structure, a Cuk converter structure, or a Zeta converter structure.
